(19) United States
(12) Patent Application Publication
(10) Pub. No.: US 2024/0430726 A1
(43) Pub. Date: Dec. 26, 2024

(54) WIRELESS POSITIONING

(71) Applicant: Nokia Technologies Oy, Espoo (FI)

(72) Inventors: Dileep KUMAR, Espoo (FI); Onel ALCARAZ LÓPEZ, Oulu (FI); Carlos MORAIS DE LIMA, Oulu (FI); Antti TÖLLI, Oulu (FI); Juha Pekka KARJALAINEN, Oulu (FI); Timo KOSKELA, Oulu (FI); Sami-jukka HAKOLA, Oulu (FI); Jari Yrjänä HULKKONEN, Oulu (FI)

(21) Appl. No.: 18/701,343

(22) PCT Filed: Oct. 22, 2021
(86) PCT No.: PCT/EP2021/079427

§ 371 Date: Apr. 15, 2024

(51) Int. Cl. H04W 24/10; H04L 5/00; H04W 24/08; H04W 64/00

(52) U.S. Cl. CPC H04W 24/10; H04L 5/0051; H04W 24/08; H04W 64/00

(57) ABSTRACT

According to an example aspect of the present invention, there is provided an apparatus, for example a user equipment, comprising at least one processing core, at least one memory including computer program code, the at least one memory and the computer program code being configured to, with the at least one processing core, cause the apparatus at least to perform a phase measurement on a first signal received wirelessly in the apparatus from a network node at a frequency or frequencies to determine phase information of the first signal, transmit a second signal to the network node using a same panel entity as was used in receiving the first signal, and cause transmission of the phase information of the first signal to a network server.

### FIELD

The present disclosure relates to facilitating the determining of a location estimate for a wireless communication node.

### BACKGROUND

Positioning wireless communication nodes is of considerable interest for a number of different application scenarios. For example, tracking of vehicles, parcels and persons, navigation services and autonomously vehicles depend on a reliable indication of a location of a wireless node. Further, various industrial automation mechanisms benefit from a highly accurate location estimate of a wireless node.

Existing methods for positioning, that is, deriving of a location estimate, include multilateration, satellite positioning and round-trip time determination.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to perform a phase measurement on a first signal received wirelessly in the apparatus from a network node at a frequency or frequencies to determine phase information of the first signal, transmit a second signal to the network node using a same panel entity as was used in receiving the first signal, and cause transmission of the phase information of the first signal to a network server.

According to a second aspect of the present disclosure, there is provided an apparatus comprising at least one processing core, at least one memory including computer program code, the at least one memory and the computer program code being configured to, with the at least one processing core, cause the apparatus at least to transmit a first signal to user equipment, perform a phase measurement on a second signal received wirelessly in the apparatus from the user equipment to determine phase information of the second signal, the second signal received using a same panel entity as was used in transmitting the first signal, and cause transmission of the phase information of the second signal to a network server.

According to a third aspect of the present disclosure, there is provided an apparatus comprising at least one processing core, at least one memory including computer program code, the at least one memory and the computer program code being configured to, with the at least one processing core, cause the apparatus at least to receive phase information of a first signal, received in a user equipment from a network node, and phase information of a second signal, received in the network node from the user equipment, add the phase information of the first signal to the phase information of the second signal, subtract the phase information of the first signal from the phase information of the second signal or subtract the phase information of the second signal from the phase information of the first signal, to obtain processed phase information, and employ the processed phase information in determining an estimate of a location of the user equipment.

According to a fourth aspect of the present disclosure, there is provided a method comprising performing a phase measurement on a first signal received wirelessly in an apparatus from a network node at a frequency or frequencies to determine phase information of the first signal, transmitting, from the apparatus, a second signal to the network node using a same panel entity as was used in receiving the first signal, and causing transmission of the phase information of the first signal from the apparatus to a network server.

According to a fifth aspect of the present disclosure, there is provided a method comprising transmitting, from a network node, a first signal to user equipment, performing, in the network node, a phase measurement on a second signal received wirelessly in the network node from the user equipment to determine phase information of the second signal, the second signal received using a same panel entity elements as was used in transmitting the first signal, and causing transmission of the phase information of the second signal from the network node to a network server.

According to a sixth aspect of the present disclosure, there is provided a method comprising receiving phase information of a first signal, received in a user equipment from a network node, and phase information of a second signal, received in the network node from the user equipment, adding the phase information of the first signal to the phase information of the second signal, subtracting the phase information of the first signal from the phase information of the second signal or subtracting the phase information of the second signal from the phase information of the first signal, to obtain processed phase information, and employing the processed phase information in determining an estimate of a location of the user equipment.

According to a seventh aspect of the present disclosure, there is provided an apparatus comprising means for performing a phase measurement on a first signal received wirelessly in the apparatus from a network node at a frequency or frequencies to determine phase information of the first signal, transmitting a second signal to the network node using a same panel entity as was used in receiving the first signal, and causing transmission of the phase information of the first signal to a network server.

According to an eighth aspect of the present disclosure, there is provided an apparatus comprising means for transmitting a first signal to user equipment, performing a phase measurement on a second signal received wirelessly in the apparatus from the user equipment to determine phase information of the second signal, the second signal received using a same panel entity as was used in transmitting the first signal, and causing transmission of the phase information of the second signal to a network server.

According to a ninth aspect of the present disclosure, there is provided an apparatus comprising means for receiving phase information of a first signal, received in a user equipment from a network node, and phase information of a second signal, received in the network node from the user equipment, adding the phase information of the first signal to the phase information of the second signal, subtracting the phase information of the first signal from the phase information of the second signal or subtracting the phase information of the second signal from the phase information of the first signal, to obtain processed phase information, and employing the processed phase information in determining an estimate of a location of the user equipment.

According to a tenth aspect of the present disclosure, there is provided a non-transitory computer readable medium having stored thereon a set of computer readable instructions that, when executed by at least one processor, cause an apparatus to at least perform a phase measurement on a first signal received wirelessly in the apparatus from a network node at a frequency or frequencies to determine phase information of the first signal, transmit a second signal to the network node using a same panel entity as was used in receiving the first signal, and cause transmission of the phase information of the first signal to a network server.

According to an eleventh aspect of the present disclosure, there is provided a non-transitory computer readable medium having stored thereon a set of computer readable instructions that, when executed by at least one processor, cause an apparatus to at least transmit a first signal to user equipment, perform a phase measurement on a second signal received wirelessly in the apparatus from the user equipment to determine phase information of the second signal, the second signal received using a same panel entity as was used in transmitting the first signal, and cause transmission of the phase information of the second signal to a network server.

According to a twelfth aspect of the present disclosure, there is provided a non-transitory computer readable medium having stored thereon a set of computer readable instructions that, when executed by at least one processor, cause an apparatus to at least receive phase information of a first signal, received in a user equipment from a network node, and phase information of a second signal, received in the network node from the user equipment, add the phase information of the first signal to the phase information of the second signal, subtract the phase information of the first signal from the phase information of the second signal or subtract the phase information of the second signal from the phase information of the first signal, to obtain processed phase information, and employ the processed phase information in determining an estimate of a location of the user equipment.

### BRIEF DESCRIPTION OF THE DRAWINGS

FIG. 1A illustrates an example system in accordance with at least some embodiments of the present invention;

FIG. 1B illustrates an example positioning architecture in New Radio, NR, accordance with at least some embodiments of the present invention;

FIG. 2 illustrates frequency assignment in accordance with at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention;

FIG. 6 is a flow graph of a method in accordance with at least some embodiments of the present invention, and

FIG. 7 is a flow graph of a method in accordance with at least some embodiments of the present invention.

### EMBODIMENTS

In positioning methods disclosed herein, a phase measurement approach is taken to deriving a location estimate for a wireless node, such as a user equipment. A phase measurement is performed in both the uplink and downlink directions, and the results of these measurements are combined to control, at least in part, error sources such as oscillator-imperfection caused phase drifts as well as clock biases. A location estimate may then be derived using the phase information, for example together with other positioning techniques, such as time-angle measurements and/or round-trip time, RTT, measurements. RTT measurements without phase measurements result in reduced accuracy, and/or a need for more participating nodes.

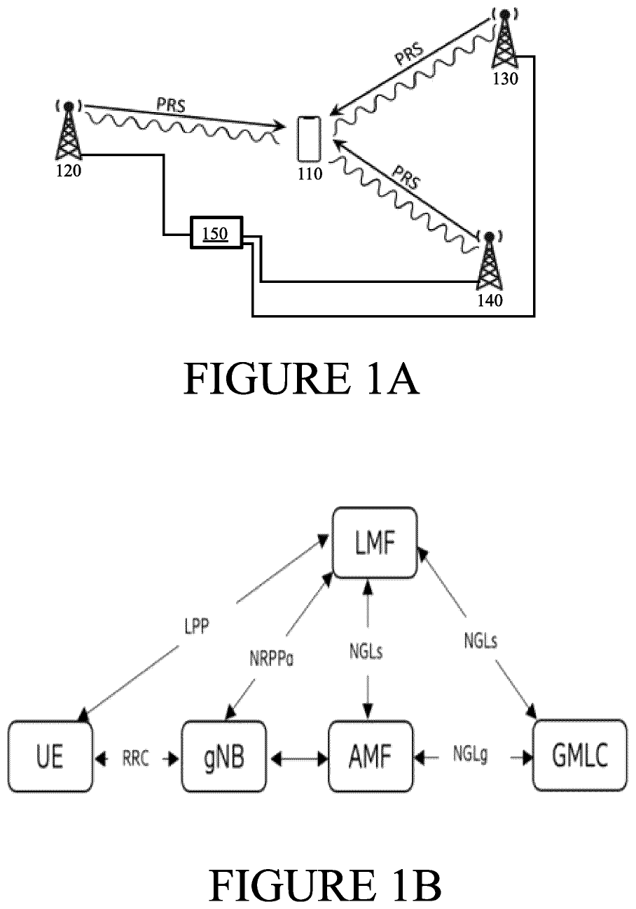

FIG. 1A illustrates an example system in accordance with at least some embodiments of the present invention. The system comprises user equipment, UE, 110, which is a target UE of a positioning process, that is, a location estimate will be determined for UE 110. The UE may comprise, in general, a smartphone, cellular phone, tablet computer, laptop computer, machine-type communication device or, for example, a communication module of a connected vehicle. The location may be expressed in the determined estimate in terms of geo-location, coordinates, or an address with reference to a map, for example. There are several technical options for deriving the location estimate, and to increase accuracy of the location estimate, more than one technically distinct mechanism for deriving the location estimate may be used together. A phase measurement based approach will be herein described, which may be used together with other methods, such as satellite positioning, RTT, angle and/or time difference of arrival, TDOA, for example.

In general, a transmitted signal, for example an unmodulated or a modulated signal, proceeds directly and its phase proceeds as a function of time. In detail, in line-of-sight, LOS, conditions, the phase proceeds linearly as a function of time, completing a full phase cycle once per wavelength, after which the phase begins once more from zero. Measuring the phase thus enables determination of a location at which the phase was measured along a wavelength, however the phase measurement does not in itself specify during which wavelength the measurement was made. Thus, the phase measurement fixes a location of the measuring device, but leaves a multiplicity in the result which may be removed by using a supplementary positioning mechanism, and/or by using more than one frequency from which the phase is measured. The phase measurement may thus be seen as providing additional accuracy to an existing positioning method in a sub-wavelength scale. What the wavelength is, depends on the frequency or frequencies used. For example, a 100 MHz tone has a three-metre wavelength and combination of 30 GHz and 30.5 GHz tones yields an overall wavelength of 30 centimetres.

The system of FIG. 1A further comprises base stations 120, 130 and 140. The base stations may be comprised in a same radio access network, or in plural ones, and the base stations may be configured to operate based on a same radio-access technology, RAT, or different RATs. Examples of RATs include 4G, also known as new radio, NR, and fifth generation, 5G, as specified by the 3^{rd} generation partnership project, 3GPP. Different RATs have differing terminology with respect to the base station, for example in in 5G this node may be known as a gNB, in 4G as an eNB and in wireless local area networks, WLANs, as an access point. In general, these are network nodes, in particular radio access network nodes. The term “base station” will be used herein as a terminological choice implying no limitation to a specific RAT. A downlink proceeds from a base station to a UE, and an uplink proceeds from a UE to one or more base station.

In the situation illustrated in FIG. 1A, base stations 120, 130 and 140 transmit downlink positioning reference signals, PRS, to UE 110. The PRS may comprise at least one modulated, information-bearing signal and/or at least one unmodulated sinusoidal signal. The PRS may comprise more than one unmodulated sinusoidal signal at different frequencies. Use of the name PRS is not to limit the present disclosure to any specific technology. The number of base stations in FIG. 1A is an example to which the disclosed technology is not limited, rather, there may be in general one or more base stations participating in the phase-measurement based positioning process which has been triggered for UE 110.

UE 110 may perform a phase measurement on each of the signals it receives to determine the phase at which the signals are received in UE 110. The received signal at UE 110 is given in LOS conditions as

$${y}_{UE} = {A}_{UE} {e}^{- j {ϕ}_{UE} ( f , r )} ,$$

where A_{UE} is the received amplitude and ϕ_{UE}(f, r) is the received phase in cycles. In line-of-sight, LOS, radio channel conditions the phase is given as

$$ϕ ( f , r ) = - \frac{2 π fr}{c} ( mod 2 π ) ,$$

where c is the speed of light, f denotes the frequency, and r is the distance between UE-base station pair. While LOS conditions are primarily envisioned here, these equations may be extended to non-LOS conditions as well.

The determined phase is phase information of the signal. UE 110 may further transmit to each of the base stations which transmitted PRS to UE 110, a PRS signal of its own, which may also comprise an information-bearing signal and/or one or more unmodulated sinusoidal signal. An uplink PRS signal may be referred to as an sounding reference signal, SRS. Advantageously, UE 110 may use the same antenna panel(s) for reception of PRS from a network node, and for transmission of PRS to that network node. This provides the advantage, that the phase properties of the PRS signals are more comparable to each other, significantly enhancing accuracy of the phase-measurement based positioning method.

A PRS may be bundled together with a phase tracking reference signal, PTRS, in the uplink and/or downlink direction. The PTRS plays a role especially at mmWave frequencies to minimize the effect of oscillator phase noise and common phase error, CPE. PTRS may be associated with one DMRS port during transmission. PTRS may be provided in scheduled bandwidth, BW, and duration used for NR-PDSCH/NR-PUSCH, which can easily be performed before the actual carrier-phase measurement. In some cases, the PRS comprises a PRS signal together with a PTRS signal in the downlink direction and an SRS signal together with a PTRS signal in the uplink direction. When the UE is configured with bundling of UL SRS and PTRS, the UE may transmit UL SRS and PTRS in different time domain symbols, that is, non-overlapping in time. The different time-domain bundling patterns of UL SRS and PTRS can be indicated to the UE by RRC and/or MAC and/or PHY level signalling. For example, bundling-PRS-PTRS-pattern1=[SRS, PTRS, PTRS] configured by RRC signalling, may define that the UE shall assume that there is phase coherence between SRS and two consecutive PTRS resources. The bundling pattern may be configured as part of UL SRS resource configuration and may be further dynamically updated and indicated by MAC and PHY level signalling. The resource configurations of UL PTRS and UL PRS define time separation of these reference signals.

The UE may be configured by the respective base station concerning which frequency, or frequencies, the PRS is to be communicated over. Such configuration may include, implicitly or explicitly, an indication that a same antenna panel, or a same antenna panel configuration comprising more than one antenna panel, is to be used in receiving and transmitting PRS from/to a same base station. The configuration from the base station may also specify whether the PRS signals in the downlink and uplink are to use the same transmission frequencies, corresponding to a symmetric case, or different transmission frequencies, corresponding to an asymmetric case. In general, the base station may configure resource elements for PRS use, wherein a resource element comprises a combination of frequency or frequencies, and time slot information which defines when the signals are to be transmitted on the frequency or frequencies. In the asymmetric case, the base station may implement correct phase measurement by taking into account the frequency difference in the propagation of the uplink signals from the UE. The configuring may define the frequency, or frequencies, using an index to a frequency table, for example. The configuring may in particular define one or more frequencies at which unmodulated sinusoidal tones are the be transmitted for phase measurement-based positioning purposes.

Due to Doppler shift owing to UE movement, the frequency at which a signal is received may slightly vary from the frequency at which the signal was transmitted. However, if the transmissions are conducted using a same frequency as defined using an index, or specific frequency in Hertz, they are on the same frequency in the sense used herein. For example thus in the symmetric case, the received and transmitted frequencies may be considered the same within the accuracy of Doppler shift caused by UE movement. Wireless communication systems often have guard bands to accommodate such frequency shifts.

In case the signals in downlink and uplink have different frequencies, the base station may configure plural alternative PRS resource sets in terms of frequency and time slots, from which the UE is able to select which one to use when transmitting the PRS in the uplink direction. The UE may have pre-determined criteria for choosing which one to use, for example. The UE may signal which PRS resource set, or sets, or PRS resource ID(s), it will use before sending the uplink PRS, for example by providing an index of a resource set it intends to use. Alternatively, the base station may know the criteria the UE will use and be enabled to anticipate which resource set(s) the UE will use even without being signalled by the UE beforehand. For example, the base station may utilize a beam-domain received signal power and/or a time-delay profile, and/or indeed other available measurements to determine the configured UE-specific uplink PRS resource sets for uplink carrier-phase measurements. In general, the PRS resources configured by the base station may be periodic, semi-persistent or aperiodic in nature.

The base stations perform phase measurements on the PRS transmitted to them by UE 110. The UE and base station may perform the phase measurements on a beam pair basis. The phase measurements conducted by base stations produce as output phase information on the PRS signals sent from UE 110, in detail, the phase of the signal as received in the respective base station. The base station may use the same antenna element(s) for reception of the PRS signal from UE 110, as was used to transmit the PRS signal from the base station to UE 110. This, again, renders the phase measurement results in UE and base station more comparable to each other. The base station may then correct for any differing frequency, or frequencies, when performing the uplink phase measurement on PRS signals the UE transmits. Alternatively, this correcting may be done in server 150. If UE 110 is stationary, the uplink and downlink PRS signals need not be transmitted at the same time.

The PRS signal base station 120 transmits to UE 110 may be referred to as a first signal, the PRS signal UE 110 transmits to base station 120 may be referred to as a second signal. The PRS signal base station 130 transmits to UE 110 may be referred to as a third signal, the PRS signal UE 110 transmits to base station 130 may be referred to as a fourth signal. The round-trip carrier phase raging measurements may be collected by the transmitter and receiver using an identical subcarrier. Here, the round-trip carrier phase ranging is ambiguous within a half-wavelength and an auxiliary procedure may be employed to resolve the ambiguity/multiplicity: for example, a velocity measurement may be used to unwrap sequential carrier-phase observations, or baseband phase measurements may be used to establish absolute offsets, or the measurement may be aided with a strapdown inertial measurement unit. Alternatively, the half-wavelength ambiguity may be resolved by measuring the phase shift at two (or more) distinct subcarriers.

Both UE 110 and base stations 120, 130, 140 may transmit the phase information they have determined from PRS signal(s) received therein to a network server 150, such as, for example, a location server. In detail, the server then receives a phase measured in the UE:

$${ϕ}_{UE} ( {f}_{k} , r ) = - 2 π {f}_{k} ( \frac{r}{c} - {Δ}_{t} ) - θ ( mod 2 π ) ,$$

and a phase measured in the base station:

$${ϕ}_{gNB} ( {f}_{k} , r ) = - 2 π {f}_{k} ( \frac{r}{c} + {Δ}_{t} ) + θ ( mod 2 π ) .$$

Here Δₜ is the time offset between the target UE and the serving gNB, and θ denotes the (hardware) phase difference between the target UE and serving gNB oscillator. Other phase errors in the transmitter and receivers may be compensated, at least in part, using phase tracking reference signal, PTRS, type signalling (by bundling of the PRS with PTRS). These are sources of error in the phase measurement. The server is then able to obtain a technical benefit in terms of overcoming these error sources by adding the received phase information together:

$${ϕ}_{k} = {ϕ}_{gNB} ( {f}_{k} , r ) + {ϕ}_{UE} ( {f}_{k} , r ) = - \frac{4 π {f}_{k} r}{c} ( mod 2 π ) .$$

In detail, the clock and phase error is removed in the additive processing in the server. Alternatively to adding, subtracting may be employed. The remaining integer ambiguity, that it, the uncertainty as to which wavelength the phase was measured from, may be resolved using a supplementary positioning method, such as satellite positioning, or one or more further signals at different frequencies in the phase-measurement based approach. When using plural frequencies in the phase-measurement approach,

$${Δ}_{ϕ} = {ϕ}_{1} - {ϕ}_{0} = - \frac{4 π ( {f}_{1} - {f}_{0} )}{c} r = - \frac{4 {πΔ}_{f}}{c} r ( mod 2 π )$$

applies, whereby the range estimate may be expressed as:

$$\hat{r} = \frac{c}{4 {πΔ}_{f}} {Δ}_{ϕ} ( mod \frac{c}{2 {Δ}_{f}} )$$

where

$$\frac{c}{2 {Δ}_{f}}$$

is the range ambiguity, which is function of sounded tones (i.e., Δ_{f}=f₁−fₒ). In other words, the ambiguity is inversely proportional to the difference in frequency Δ_{f}. As the range ambiguity is inversely proportional to Δ_{f}, a non-phase measurement based positioning method is first used to obtain a first location estimate, and later it is used to fine-tune and schedule appropriate positioning support signal parameters, such as sub-carriers fₖ and other phase parameters, for reduced integer ambiguity. For example with frequencies 30 GHz and 30.5 GHz, the associated virtual wavelength is 30 cm. Another example is where the frequencies are 30 GHz and 31 GHz, which are associated with a virtual wavelength of 15 cm. Thus, in the disclosed method ambiguity computation does not depend on a specific frequency but on the frequency difference, Δ_{f}.

In general, in case the uplink and downlink PRS signals are sent concurrently, that is, at the same time, accuracy of the positioning is enhanced since the UE does not move between the uplink and downlink phase measurements.

As noted above, an RTT measurement, typically based on multilateration, may require at least three RTT measurements from spatially distributed base stations or transmission-reception points. In RTT measurements, further, localization accuracy is dominated by worst-case accuracy of each RTT measurement. Further, clock biases and systemic delay errors affect the accuracy of RTT measurements. Multi-cell RTT measurements may also require tight synchronization between spatially distributed base stations. For example, a synchronization error of 100 nanoseconds may result in a localization error of 30 metres.

FIG. 1B illustrates an example positioning architecture in new radio, NR, accordance with at least some embodiments of the present invention. AMF corresponds to access and mobility management function and GMCL to gateway mobile location centre. RRC corresponds to radio resource control, LPP to long term evolution, LTE, positioning protocol, NRPP to new radio positioning protocol and NGL is a reference point in the NR architecture. The LMF is a location server, which may be configured to receive the phase information from the UE and base stations.

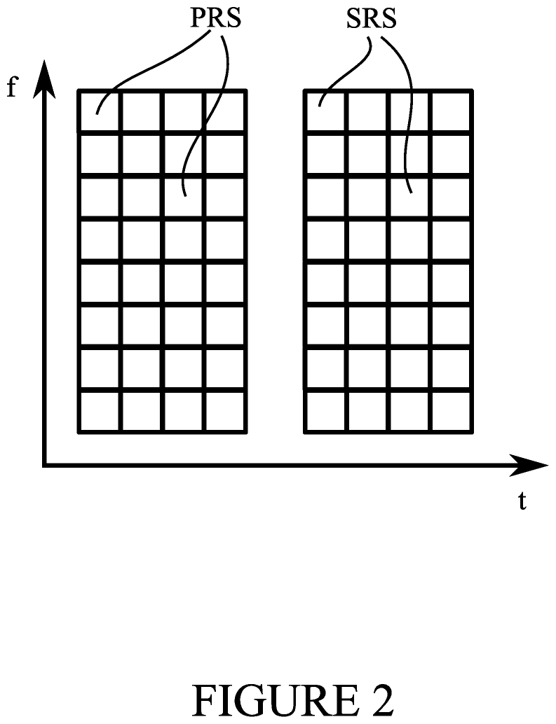

FIG. 2 illustrates frequency assignment in accordance with at least some embodiments of the present invention. Frequency increases toward the top of the figure on the vertical axis f, and time advances from the left to the right along the horizontal axis t. In the illustrated example, the resource allocation is symmetric in that the downlink PRS signal uses the same two frequencies as the uplink SRS signal.

In some embodiments, the base station configures, and triggers, the target UE 110 for multiple uplink signal transmissions for phase measurement on the same resource elements for the uplink carrier-phase measurements. Thus, by knowing the predefined number of copies and the respective time-frequency gaps, or a time offset between multiple copies, the base station correspondingly implements time and phase corrections to obtain accurate phase measurement.

The base station may implement a hierarchical selection and/or a weighted combination of the phase information received in the uplink direction. Alternatively, with power control, which may be open or closed loop based, the base station may request a power boosting on the selected uplink signal transmission direction to improve the received signal quality, and thus achieve more accurate phase measurement.

Alternatively to what is disclosed above, the phase information reported from the UE and base stations may comprise only a phase difference obtained over multiple resource elements of multiple reference signals for the carrier phase measurements.

While described above primarily in terms of unmodulated reference signals, the herein disclosed carrier-phase measurements could be, obtained from also from modulated signals. Thus, in-band signaling provides the opportunity to select and fine-tune carriers for reduced location ambiguities, also to carry out uplink power-boosting options due to using modulated signals. Uplink resources usable in carrier phase measurements include, for example, sounding reference signal, SRS, DMRS of physical uplink shared channel, PUSCH, DMRS of the physical uplink control channel, PUCCH, UL phase-tracking tracking reference signal, PTRS, and physical random-access channel, PRACH, preambles Likewise, usable downlink resources include non-zero-power channel state information reference signal, NZP-CSI-RS, for beam management, BM, time-frequency tracking, CSI acquisition, positioning reference signal, PRS, phase tracking reference signal, PTRS, demodulation reference signal, DMRS of the physical downlink shared channel, PDSCH, DMRS of physical downlink control channel, PDCCH, and a synchronization signal block, SSB, transmission.

It should be noted that to simplify the exposition, in this disclosure the focus is on UE-assisted RAT-dependent downlink positioning scenarios. However, the described mechanisms can be extended to, network-assisted UE-based uplink positioning scenarios by the person skilled in the related art.

The chosen uneven and/or symmetric and/or non-symmetric resource element mapping patterns of resources of UL/DL PRS type resource sets, which may include the hopping patterns, masking patterns, power-boosting, bandwidth and periodicity, and the choice of the control/selection metrics are internal to base stations. For example, Rel-16 supports the configuration of resources with N_{symb}∈{1,2,4,8,12} symbols located in anywhere is a slot and comb-size {2, 4, 8}. Carrier phase measurements may be conducted as beam-based processing and involve beam pair specific measurements. The herein disclosed carrier phase-based mechanism exploits delay and angle resolution so that each resolvable multipath component in the beam space domain may be evaluated per beam-pair separately.

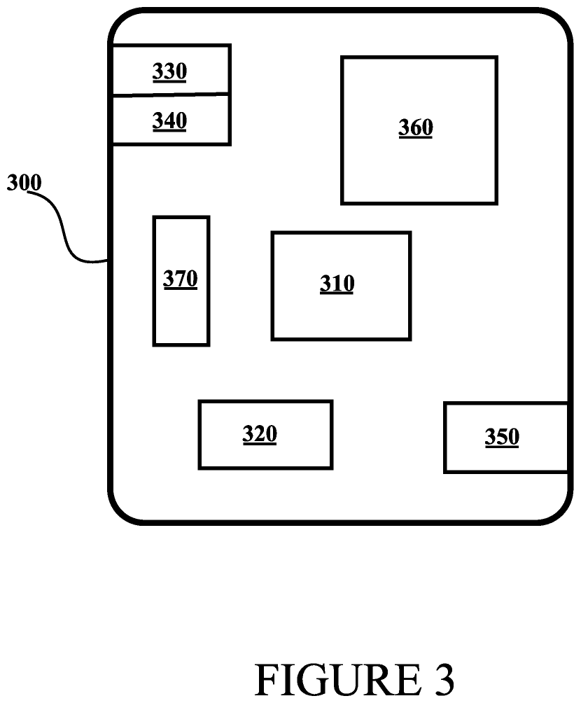

FIG. 3 illustrates an example apparatus capable of supporting at least some embodiments of the present invention. Illustrated is device 300, which may comprise, for example, a mobile communication device such as UE 110, or, in applicable parts, base station 120 or server 150 of FIG. 1A. Comprised in device 300 is processor 310, which may comprise, for example, a single-or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as performing, transmitting, causing transmission, receiving, adding, subtracting, or employing. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

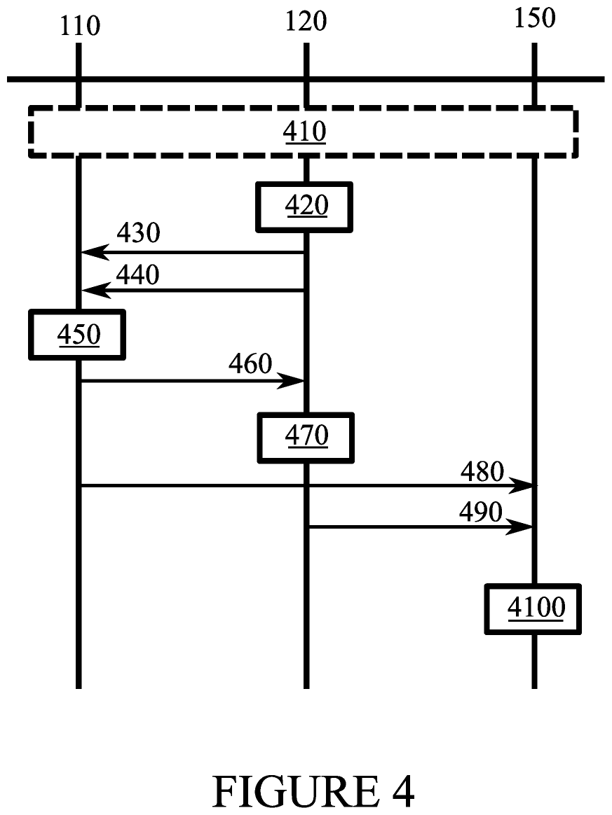

FIG. 4 illustrates signalling in accordance with at least some embodiments of the present invention. On the vertical axes are disposed, on the left, US 110 of FIG. 1A, in the centre, base station 120 of FIG. 1A and on the right, server 150 of FIG. 1A. Time advances from the top toward the bottom.

Optional phase 410 comprises an initial reference signal configuration and its associated information exchange. The configuration comprises indication of time and frequency resources to be used in transmission of reference signals. Where this phase is absent, the base station determines and configured frequency and time resources to be used in reference signal transmission.

Phase 420 comprises base station 120 determining uplink resources for the transmission of positioning reference signal(s), which may be referred to as SRS type resources. In the example of FIG. 4, the used resources are symmetric, that is, occurring on the same frequency or frequencies in the uplink and downlink. In phase 430, base station 120 configures UE 110 with the information determined in phase 420.

In phase 440, base station 120 transmits positioning support signal(s) to UE 110. This transmission may employ PRS type resources. As noted above, this may comprise one or more unmodulated sinusoidal tones, optionally in addition to a modulated signal. These are measured by UE 110 in phase 450, which takes place during phase 440. In detail, phase information of the signal(s) received in phase 440 is determined in the measurement of phase 450.

In phase 460, UE 110 transmits a signal using the resources configured in phase 430 to base station 120, which conducts a phase measurement on the signal in phase 470. UE 110 and base station 120 report the phase information obtained in phases 450 and 470 to server 150 in phases 480 and 490, respectively. Phases 480 and 490 may occur in either order, phase 480 first or phase 490 first, or they may be at least partly concurrent.

Finally, in phase 4100, server 150 may add the phase information received in phases 480 and 490 together, to control phase and clock error in the phase measurements, to obtain processed phase information usable in obtaining a phase measurement based location estimate for UE 110.

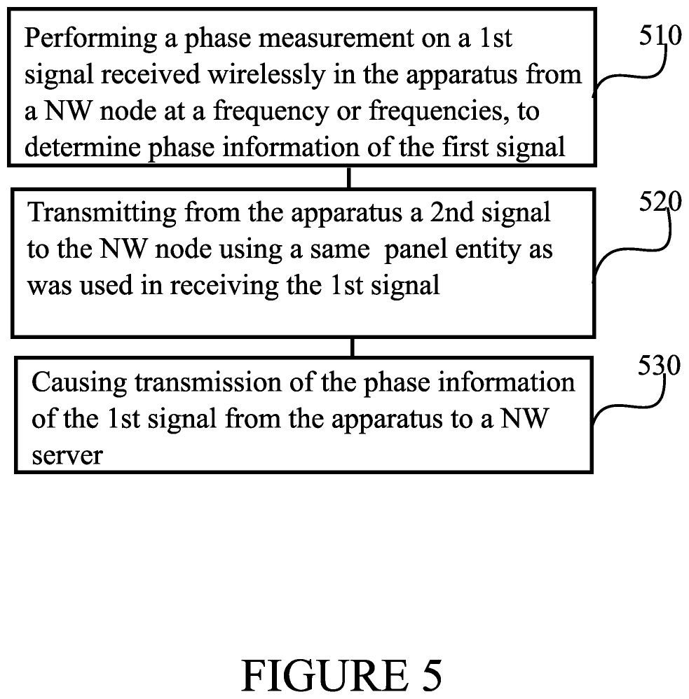

FIG. 5 is a flow graph of a method in accordance with at least some embodiments of the present invention. The phases of the illustrated method may be performed in UE 110, an auxiliary device or a personal computer, for example, or in a control device configured to control the functioning thereof, when installed therein.

Phase 510 comprises performing a phase measurement on a first signal received wirelessly in an apparatus from a network node at a frequency or frequencies to determine phase information of the first signal. In other words, the phase measurement is conducted to determine the phase information, and the phase information is an output of the phase measurement. Phase 520 comprises transmitting, from the apparatus, a second signal to the network node using a same panel entity as was used in receiving the first signal. Phase 530 comprises causing transmission of the phase information of the first signal from the apparatus to a network server. A panel entity comprises an antenna panel entity, such as a specific combination of antenna panels, or a specific single antenna panel.

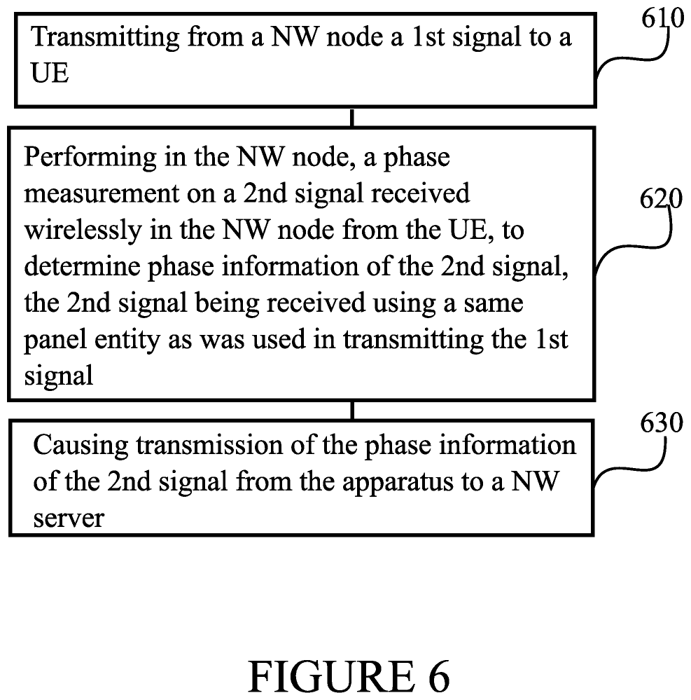

FIG. 6 is a flow graph of a method in accordance with at least some embodiments of the present invention. The phases of the illustrated method may be performed in a base station or other radio-enabled network node, an auxiliary device or a personal computer, for example, or in a control device configured to control the functioning thereof, when installed therein.

Phase 610 comprises transmitting, from a network node, a first signal to user equipment. Phase 620 comprises performing, in the network node, a phase measurement on a second signal received wirelessly in the network node from the user equipment to determine phase information of the second signal, the second signal received using a same panel entity as was used in transmitting the first signal. In other words, the phase measurement is conducted to determine the phase information, and the phase information is an output of the phase measurement. Phase 630 comprises causing transmission of the phase information of the second signal from the network node to a network server. A panel entity comprises an antenna panel entity, such as a specific combination of antenna panels, or a specific single antenna panel.

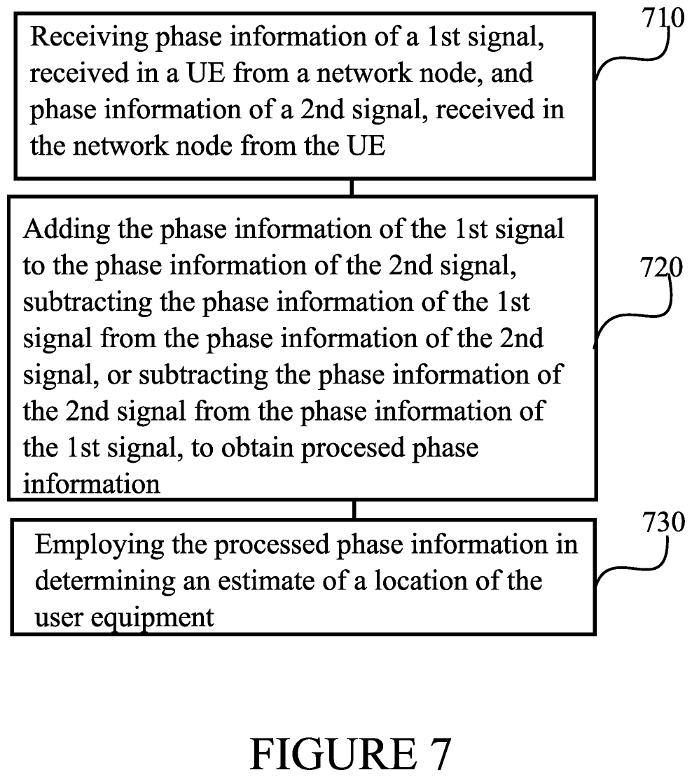

FIG. 7 is a flow graph of a method in accordance with at least some embodiments of the present invention. The phases of the illustrated method may be performed in UE 110, an auxiliary device or a personal computer, for example, or in a control device configured to control the functioning thereof, when installed therein.

Phase 710 comprises receiving phase information of a first signal, received in a user equipment from a network node, and phase information of a second signal, received in the network node from the user equipment. Phase 720 comprises adding the phase information of the first signal to the phase information of the second signal, subtracting the phase information of the first signal from the phase information of the second signal or subtracting the phase information of the second signal from the phase information of the first signal, to obtain processed phase information. Finally, phase 730 comprises employing the processed phase information in determining an estimate of a location of the user equipment.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in positioning of wireless nodes.

### ACRONYMS LIST

DMRS demodulation reference signal
MAC medium access control
PHY physical layer
PDSCH physical downlink shared channel
PUSCH physical uplink shared channel
PRS positioning reference signal
RRC radio resource control
SRS sounding reference signal

REFERENCE SIGNS LIST

| | |
|---|---|
| 110 | user equipment |
| 120, 130, | base station |
| 140 | |
| 150 | server |
| 300-370 | structure of the device of FIG. 3 |
| 410-4100 | phases of the process of FIG. 4 |
| 510-530 | phases of the method of FIG. 5 |
| 610-630 | phases of the method of FIG. 6 |
| 710-730 | phases of the method of FIG. 5 |

1. An apparatus comprising at least one processing core, at least one memory including computer program code, the at least one memory and the computer program code being configured to, with the at least one processing core, cause the apparatus at least to:
perform a phase measurement on a first signal received wirelessly in the apparatus from a network node at a frequency or frequencies to determine phase information of the first signal, wherein the first signal is a downlink positioning reference signal;
transmit a second signal to the network node using a same panel entity as was used in receiving the first signal, wherein the second signal is an uplink sounding reference signal, and
cause transmission of the phase information of the first signal to a network server.

2. The apparatus according to claim 1, wherein the at least one memory and the computer program code are configured to, with the at least one processing core, cause the apparatus to process an instruction from the network node, the instruction identifying the frequency or the frequencies of the first signal.

3. The apparatus according to claim 1, wherein the apparatus is configured to perform the transmitting of the second signal at the same frequency, or frequencies, as the first signal was transmitted on.

4. The apparatus according to claim 1, wherein the apparatus is configured to perform the transmitting of the second signal at a different frequency, or where the first signal has more than one frequency, at different frequencies than the transmission of the first signal.

5. The apparatus according to claim 1, wherein the first signal and the second signal each comprise one or more unmodulated sinusoidal signal.

6. The apparatus according to claim 1, wherein the at least one memory and the computer program code are configured to, with the at least one processing core, cause the apparatus to receive a third signal, from a second network node, at least in part concurrently with the first signal, and to transmit a fourth signal, at least in part concurrently with the second signal, back to the second network node, the fourth signal being sent using a same panel entity as used in receiving the third signal.

7. An apparatus comprising at least one processing core, at least one memory including computer program code, the at least one memory and the computer program code being configured to, with the at least one processing core, cause the apparatus at least to:
transmit a first signal to user equipment, wherein the first signal is a downlink positioning reference signal;
perform a phase measurement on a second signal received wirelessly in the apparatus from the user equipment to determine phase information of the second signal, the second signal received using a same panel entity as was used in transmitting the first signal, wherein the second signal is an uplink sounding reference signal, and
cause transmission of the phase information of the second signal to a network server.

8. The apparatus according to claim 7, wherein the at least one memory and the computer program code are configured to, with the at least one processing core, cause the apparatus to transmit an instruction to the user equipment, the instruction identifying the frequency or the frequencies of the first signal.

9. The apparatus according to claim 7, wherein the first signal and the second signal each comprise one or more unmodulated sinusoidal signal.

10. The apparatus according to claim 7, wherein the network server comprises a location server.

11-13. (canceled)

14. A method comprising:
performing a phase measurement on a first signal received wirelessly in an apparatus from a network node at a frequency or frequencies to determine phase information of the first signal, wherein the first signal is a downlink positioning reference signal;
transmitting, from the apparatus, a second signal to the network node using a same panel entity as was used in receiving the first signal, wherein the second signal is an uplink sounding reference signal, and
causing transmission of the phase information of the first signal from the apparatus to a network server.

15. The method according to claim 14, further comprising processing an instruction from the network node, the instruction identifying the frequency or the frequencies of the first signal.

16. The method according to claim 14, wherein the method comprises performing the transmitting of the second signal at the same frequency, or frequencies, as the first signal was transmitted on.

17. The method according to claim 14, wherein the method comprises performing the transmitting of the second signal at a different frequency, or where the first signal has more than one frequency, at different frequencies than the transmission of the first signal.

18. The method according to claim 14, wherein the first signal and the second signal each comprise one or more unmodulated sinusoidal signal.

19. The method according to claim 14, further comprising causing the apparatus to receive a third signal, from a second network node, at least in part concurrently with the first signal, and to transmit a fourth signal, at least in part concurrently with the second signal, back to the second network node, the fourth signal being sent using a same antenna panel entity as the reception of the third signal.

20-32. (canceled)

33. The apparatus according to claim 1, wherein the network server comprises a location server.
